(19) United States
(12) Patent Application Publication
(10) Pub. No.: US 2008/0127322 A1
(43) Pub. Date: May 29, 2008

(54) SOLICITED REMOTE CONTROL IN AN INTERACTIVE MANAGEMENT SYSTEM

(75) Inventors: Keith A. McCall, Sammamish, WA (US); Ronald S. Woan, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: AZALEOS CORPORATION, Redmond, WA (US)

(21) Appl. No.: 11/946,757

(22) Filed: Nov. 28, 2007

Related U.S. Application Data
(60) Provisional application No. 60/867,455, filed on Nov. 28, 2006.

(51) Int. Cl. G06F 21/22; G06F 15/16

(52) U.S. Cl. 726/11; 709/203

(57) ABSTRACT

An interactive management system comprised of a server environment and one or more target client environments coupled to a management server of the server environment is described herein. The target client environments may each have one or more target client systems, the target client systems each having a command agent. Each target client environment may also be protected by a firewall. In some embodiments, a commander server of the server environment may receive a request for one or more commands from a target client system. In response, the command server may send commands to the command agent of the requesting target client system, effectively giving the command server the same privileges as other processes protected by the target client environment firewall. The command agent may then receive the commands, execute the commands, and transmit results and/or post-execution information to the command server.

### RELATED APPLICATIONS

The present non-provisional application claims priority to provisional application No. 60/867,455, entitled “Solicited Remote Control in an Interactive Management System”, filed Nov. 28, 2006.

### FIELD OF THE INVENTION

The present invention relates to the fields of data processing and remote systems control, and in particular to an interactive management system providing a management server with a virtual presence within a potentially firewall-protected target client environment through a client-initiated command request.

### BACKGROUND OF THE INVENTION

Advances in networking and distributed applications have given rise to the need and desire to monitor, update, and potentially fix client applications on a plurality of client devices by server applications on server systems that are remote from the client devices, even for medium size networks. However, due to increasing security concerns because of hackers, virus attacks and so forth, client devices and internal networks are often protected by firewall applications. As a result, remote management of client devices has become something practiced by large enterprise networks, through the use of private remote management servers managing within the vast internal enterprise network. Medium size networks that would otherwise prefer to delegate remote management to outside third parties have increasingly found themselves having to forsake remote management in favor of security or reluctantly take on the remote management internally.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flowchart view of selected command agent operations, in accordance with various embodiments;

FIG. 3 illustrates a first flowchart view of selected command server operations, in accordance with various embodiments; and

FIG. 4 is a block diagram illustrating an example computer system suitable for use to practice the present invention, in accordance with various embodiments.

### DETAILED DESCRIPTION OF EMBODIMENTS OF THE INVENTION

Illustrative embodiments of the present invention include, but are not limited to, an interactive management system comprised of a management server and one or more target client environments coupled to the management server to be managed by the management server. The target client environments may each have one or more client systems, and may also be protected by a firewall. Due to the teachings of the present invention endowed to the interactive management system and the target environments, the target client environment may be a medium size enterprise network, and the interactive management system may be operated by an unrelated outside third party. Typically, the outside third party may operate the interactive management system to manage a plurality of unrelated target environments.

In various embodiments, the management server and target systems have a commander server and command agents respectively, endowed with the teachings of the present invention to enable the target client systems to be manageable by the management server, notwithstanding the potential presence of the firewall. The command agent is configured to initiate and transmit management requests/solicitations for command sets to the command server. In response, the command server may send a command set comprised of one or more commands to the command agent of the requesting target client system for execution, to effectively give the command server the same privileges as one or more other processes protected by the target client environment firewall. On receipt, the command agent may cause the commands to be executed. In various embodiments, the command agents are further adapted to gather the execution results or post-execution information, and transmit the results and/or information to the command server.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

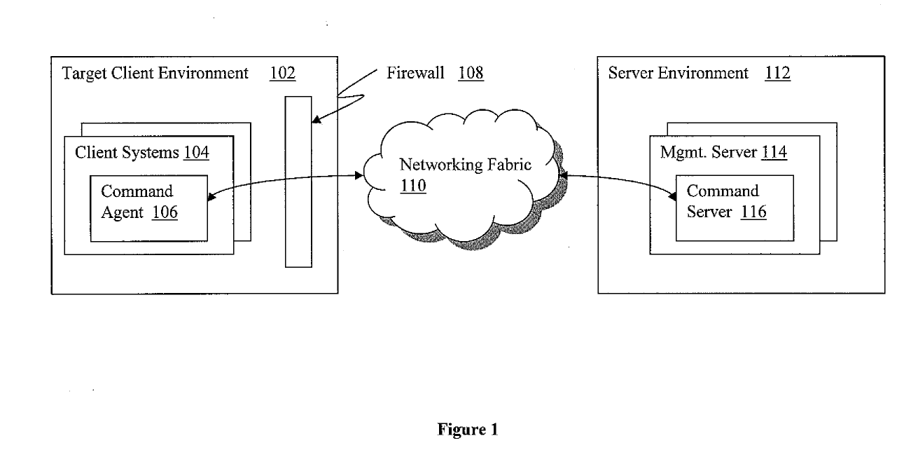

FIG. 1 illustrates an overview of various embodiments of the present invention. As illustrated, each of one or more firewall protected target client environments, such as target client environment 102 may include one or more target client systems 104 which may be communicatively coupled to one or more management servers 114 of a server environment 112 via a networking fabric 110. As alluded to earlier, in various embodiments, the firewall protected target client environments 102 and the server environment 112 may be complementarily endowed to enable each of firewall protected target client environments 102 to be remotely managed by server environment 112, notwithstanding the fact the environments 102 are firewall protected. In various embodiments, each target client environment 102 may be of a different enterprise, and server environment 112 may be operated by a third party unrelated to the different enterprises. The term “enterprise” as used herein refers to a commercial or non-commercial entity, such as a multinational enterprise like IBM, a state or municipal government, or a charity organization like the American Red Cross.

In various embodiments, each target client system 104 may include a command agent 106 capable of formulating and transmitting requests/solicitations for command sets to a command server 116 of a management server 114. The command server 116 may then responsively determine and transmit a command set comprising one or more commands to the requesting command agent 106, thus giving the command server 116 a virtual presence behind the firewall 108 within target client environment 102. The command agent 106 may then execute the received commands, and in various embodiments, transmit results of execution and/or post-execution information to the command server 116. In some embodiments, the command server 116 may formulate commands based on execution results/information of previous commands, or based on data obtained by a separate monitoring process. In one embodiment, each command may be associated with a security level, and the command agent 104 may check the security level to determine if it is sufficient for the command associated with it to be executed.

In various embodiments, the target client environment 102 may comprise a grouping of target client systems coupled to networking fabric 110 through a firewall 108 of the target client environment. In one embodiment, target client environment 102 may be an enterprise having a plurality of computer systems, such as target client systems 104, the computer systems coupled by an intranet, such as a private local area network (LAN) or a private wide area networking (WAN). In such an embodiment, connections to devices available over networking fabric 110 may be made only through one or more gateway computer systems comprising firewall 108, firewall 108 providing a measure of security to target client environment 102. Also, in such an embodiment, the target client systems 104 may comprise application servers which may in turn be monitored and maintained by a remote service provider, such as server environment 112.

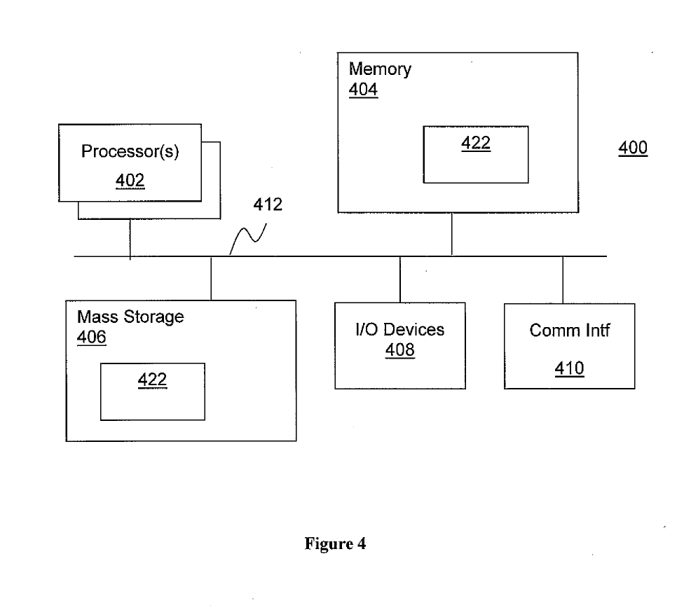

As is shown, the one or more target client systems 104 may be any sort of computing devices known in the art, except for command agent 106 and other processes, discussed below, such as monitoring processes. Target client systems 104 may be personal computers (PC), workstations, servers, routers, mainframes, or modular computers within blade servers or high-density servers, in some embodiments. Further, target client systems 104 may be any single- or multi-processor or processor core central processing unit (CPU) computing systems known in the art, except for command agent 106 and other processes, discussed below, such as monitoring processes. An exemplary single-/multi-processor or processor core target client system 104 is illustrated by FIG. 4, and is described in greater detail below.

In some embodiments, as mentioned above, target client systems 104 may be application servers. In one embodiment, a target client system 104 may be an email server, such as a Microsoft Exchange server, providing email services to other computer systems of the target client environment 102. Such a target client system 104 may have both command agent 106 and a monitoring process, such as a monitoring agent, to facilitate a remote service provider in monitoring and maintaining target client system 104 despite the existence of firewall 108. The monitoring agent may gather statistics about the health of target client system 104 and its processes, and may provide the statistics to a remote monitoring server of a server environment 112. An exemplary monitoring agent is described in detail by co-pending U.S. patent application Ser. No. 11/322,758, entitled “Active Statistical Rules-Based Monitoring of Distributed Systems and Functionality for an Enterprise Directory and Messaging Server Infrastructure” and filed Dec. 30, 2005, that application fully incorporated herein by reference.

In addition to monitoring processes and the command agent 106, target client system 104 may have one or more wired or wireless networking interfaces enabling the target client system 104 to communicate with firewall 108, and through firewall 108 with networking fabric 110. Such networking interfaces may be of any type known in the art. In some embodiments, the networking interfaces may use any transport protocol known in the art, such as the Transmission Control Protocol/Internet Protocol (TCP/IP) suite of protocols, and may use any communication protocol known in the art, such as Simple Object Access Protocol (SOAP) over Secure Hypertext Transfer Protocol (HTTPS) and/or Microsoft Message Queue (MSMQ) over HTTPS.

As is shown, each target client system 104 may have a command agent 106 capable of requesting/soliciting command sets of a remote service provider, such as management server 114 of server environment 112, receiving the command sets, executing at least some of the commands of the command sets, and sending results to the remote service provider, such as command server 116 of a management server 114. Identity information about the remote service provider, such as an IP address, may be part of the command agent 106 application, may be received from a target client system 104 user, or may be received from the remote service provider as part of a message capable of reaching the target client system 104 through firewall 108. At some pre-defined interval, such as a one minute time interval, or at the occurrence of some pre-defined event, command agent 106 may formulate and transmit a command request/solicitation to a computer identified by the identity information. The command request may comprise a SOAP over HTTPS message and may include identity information about the target client system 104. At some later point or points in time, command agent 106 may receive a SOAP over HTTPS message responsive to the request, the response including zero, one, or more commands in one or more command sets for command agent 106 to execute. Command agent 106 may read and execute the commands, receive execution results or post-execution information, and send the execution results/information to the remote service provider as an MSMQ over HTTPS message. In executing the commands, command agent 106 may execute the commands of each command set serially.

In some embodiments, the received commands may be a script of commands, the script comprising either a single command set or a plurality of command sets. Commands may direct a fingerprinting operation of target client system 104, a log file cleanup, a gathering of health statistics, and a directive informing a monitoring agent of target client system 104 what to monitor. Other commands may direct the fixing of a target client system 104 fault. Such commands may provide the command server 116 of a remote service provider with a virtual presence within the target client environment 102, allowing maintenance of the target client environment 102 without requiring the target client environment 102 to alter its IT infrastructure.

In various embodiments, responses from the command server 116 to command agent 106 requests may further include a digital certificate, such as an X.509 certificate, to provide an additional layer of security to the command response. Such certificates are well known in the art. Also, or instead, such responses may be protected by a public/private key encryption scheme. In one embodiment, in the event of a security breach, the remote service provider may direct command agent 106 to revoke remote service provider certificates. In such an embodiment, when command agent 106 attempts to verify the certificate of the compromised service provider, the verification will fail, and command agent 106 may not execute the potentially compromised commands comprising the response.

Also, commands of responses from the command server 116 to command agent 106 requests may be associated with security levels. For example, various personnel and/or processes of the remote service provider may each be assigned a security level. Commands generated by the personnel/process may be associated with the security level, and the security level may be transmitted along with the commands. Command agent 106 may then determine the type of command, for each command, a required security level for that type of command (i.e., a threshold), and the security level provided with the command. If the type of command requires a higher security level than security level provided with the command, the command agent 106 may not execute the command, and may, in some embodiments, transmit this failure back to the command server 116.

Further, in various embodiments, the command agent 106 may also or instead verify privilege information associated with the one or more commands of the command set by comparing the privilege information to locally stored credentials. Such credentials comprise an access control list (ACL) stored on one of client systems 104.

In some embodiments, firewall 108 may be any sort of firewall known in the art. Firewall 108 may be implemented via hardware or software, and may reside on one or more computer systems of target client environment 102, the computer systems serving as gateways between a target client environment 102 intranet and networking fabric 110. Firewall 108 may be any one or more of a packet filter, an application gateway, a circuit-level gateway, a proxy server, or any other sort of firewall 108 known in the art. In various embodiments, firewall 108 may operate to prevent unauthorized access to target client environment 102. The computer system(s) having firewall 108 may also have one or more networking interfaces of the types described above in reference to target client systems 104 to enable communication between target client systems 104 and other devices across networking fabric 110, such as communications between target client systems 104 and management servers 114. Firewall 108 may require, however, that such communications be initiated by target client systems 104.

As illustrated, networking fabric 110 may include one or more of a public WAN and the Internet. Communications across the networking fabric 110 may be facilitated by any communication protocol known in the art, such as the SOAP over HTTPS, MSMQ over HTTPS, the Hypertext Transfer Protocol (HTTP) or the file transfer protocol (FTP), and any transport protocol known in the art, such as TCP/IP. In some embodiments, networking fabric 110 may comprise a plurality of connected routers at sites remote from each other.

In various embodiments, server environment 112 may comprise a plurality of computer systems, including management servers 114, accessible through networking fabric 110. The plurality of computer systems of server environment 112 may form an intranet, such as a private LAN or WAN. The server environment 112 may, in some embodiments, comprise a service provider, such as a network operations center, capable of monitoring and maintaining application servers, such as Microsoft Exchange servers, in a target client environment 102. Each computer system of server environment 112 may have a role within the server environment, such as a database server, an application server, a security server, or a user terminal.

As is shown, the one or more management servers 114 may be any sort of computing devices known in the art, except for command server 116 and other processes, discussed below, such as monitoring processes. Management servers 114 may be personal computers (PC), workstations, servers, routers, mainframes, or modular computers within blade servers or high-density servers, in some embodiments. Further, management servers 114 may be any single- or multi-processor or processor core central processing unit (CPU) computing systems known in the art, except for command server 116 and other processes, discussed below, such as monitoring processes. An exemplary single-/multi-processor or processor core management server 114 is illustrated by FIG. 4, and is described in greater detail below.

In some embodiments, as mentioned above, management servers 114 may be application servers. In one embodiment, a management server 114 may be a service providing server, having processes such as command server 116, a monitoring server, and web services, the processes for monitoring and maintaining systems 104 in a target client environment 102. The processes may also make use of stored procedures stored on a database server of server environment 112, which may in turn retrieve data and commands for use by, for example, command server 116. In one embodiment, the processes of management servers 114 may also interact with console processes of a user terminal of server environment 112, such as a user interface, receiving inputs from users.

In some embodiments, a monitoring server of a management server 114 may receive statistics about the health of a target client system 104 and its processes, and may perform rules based processing on the statistics to generate one or more health metrics. Such metrics may be used, for example, by command server 116 in determining commands. An exemplary monitoring server is described in detail by co-pending U.S. patent application Ser. No. 11/322,758, entitled “Active Statistical Rules-Based Monitoring of Distributed Systems and Functionality for an Enterprise Directory and Messaging Server Infrastructure” and filed Dec. 30, 2005, that application fully incorporated herein by reference.

In addition to monitoring processes and the command server 116, management server 114 may have one or more wired or wireless networking interfaces enabling the target client system to communicate with a target client system 104 of a target client environment 102, either directly or through a firewall 108. Such networking interfaces may be of any type known in the art. In some embodiments, the networking interfaces may use any transport protocol known in the art, such as TCP/IP, and may use any communication protocol known in the art, such as SOAP over HTTPS and/or MSMQ over HTTPS.

As illustrated, a command server 116 of a management server 114 may receive command requests/solicitations from command agents 106 of target client systems 104 in target client environments. In some embodiments, such a request/solicitation may be received from each target client system 104 at a pre-defined time interval, such as one minute. Each request may comprise a SOAP over HTTPS message, and may specify identity information about the target client system 104 sender, such as an IP address. In response to each received request, command server 116 may formulate at least one command set comprising one or more commands to send to the requesting command agent 106. Exemplary commands are described in greater detail above. Command server 116 may form the commands automatically, based on one or more rules or procedures, or may require inputs from a server environment 112 user, through, for example, a command console of the server environment 112. Further, in some embodiments, command server 112 may facilitate a server environment 112 user of the command server 116 in specifying the commands of a command set by presenting the user with one or more selectable commands. The commands may also comprise SOAP over HTTPS messages, and may be organized as a script of commands to be executed sequentially. Command server 116 may then transmit a command set response to each requesting command agent 106, and may await results. In various embodiments, command server 116 may receive the results of command execution from command agents 106 at a later point or points in time in the form of an MSMQ message. Such results may indicate a success or failure status for each of the executed commands. In one embodiment, command server 116 may store the results in a database of a database server of server environment 112, or may perform some other processing of the results.

In some embodiments, command server 116 may formulate commands based on the results of previous command executions or based on monitoring statistics, such as those described above. Thus, command server 116 is able to manage target client systems 104 in an interactive fashion, formulating new commands based on the execution of previous commands or based on statistics gathered about the target client systems 104. In one embodiment, commands may be formulated for a target client system 104 based on execution results or post-execution information of previous commands received from a number of other target client systems, or based on statistics gathered above other systems. Previous execution results/information and statistics may be retrieved by command server 116 from, for example, from one or more databases of a database server of server environment 112. Commands may be automatically formulated from the results and/or statistics, with the command server 116 making reference to one or more stored procedures, or may, as described above, be formulated and entered by server environment 112 users/personnel.

In a number of embodiments, command server 116 may provide a measure of security by including with the command results one or more digital certificates, such as those discussed above, or through use of public/private key encryption. Should the server environment become compromised, it may notify target client systems 104 to revoke the digital certificates, through a command from the command server 116, for example.

Also, users/personnel of the server environment 112 may each be assigned a security level, as described above. Commands entered by a user may be associated with the user's security level, and that level may be transmitted by the command server 116 with the command results. In one embodiment, associated with command formulation may also be assigned security levels.

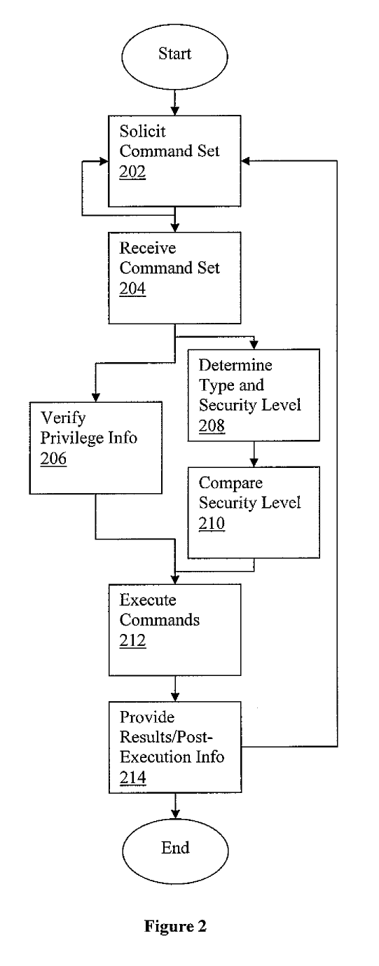

FIG. 2 illustrates a flowchart view of selected command agent operations, in accordance with various embodiments. As illustrated, a command agent of a target client environment may solicit from a command server a command set, block 202, the target client environment being remotely disposed from the command server, the target client environment including a firewall restricting access by the command server. The target client environment and the command server may be operated by different enterprises. In particular, the command server may be operated by an unrelated third party, designed to remotely manage a number of target client environments of different enterprises. In one embodiment, the command agent may repeat the soliciting, block 202, on a predetermined basis.

In various embodiments, in response to the soliciting, block 202, the command agent may receive the command set, block 204, the command set including one or more commands. In some embodiments, the command agent may also receive additional command sets with the received command set, each additional command set including additional one or more commands, the commands within each command set to be executed serially. In various embodiments, the commands may direct at least one of a fingerprinting operation, a log file cleanup, a gathering of health statistics, a monitoring directive for a monitoring process of the target client environment, or a directive to fix a fault.

In some embodiments, the command agent may then, prior to executing the commands, block 212, verify privilege information associated with the one or more commands of the command set by comparing the privilege information to locally stored credentials, block 206. In other embodiments, the command agent may then determine for each of the commands in the command set, a command type and a security level associated with the command, block 208, and may compare the security level for each command to a threshold level associated with the command type for that command, block 210, and, if the threshold is not met, may not execute the command.

As illustrated, the command agent may next execute at least one of the one or more commands to provide the command server with a virtual presence within the target client environment and with privileges equivalent to those of another process protected by the firewall, block 212. The command agent may then provide results and/or post-execution information to the command server to enable the command server to determine additional command sets, block 214. In some embodiments, the results may indicate a success or failure status for each of the executed commands. In various embodiments, communication between the command agent and the command server may be secured by a public/private key encryption scheme and/or a certificate.

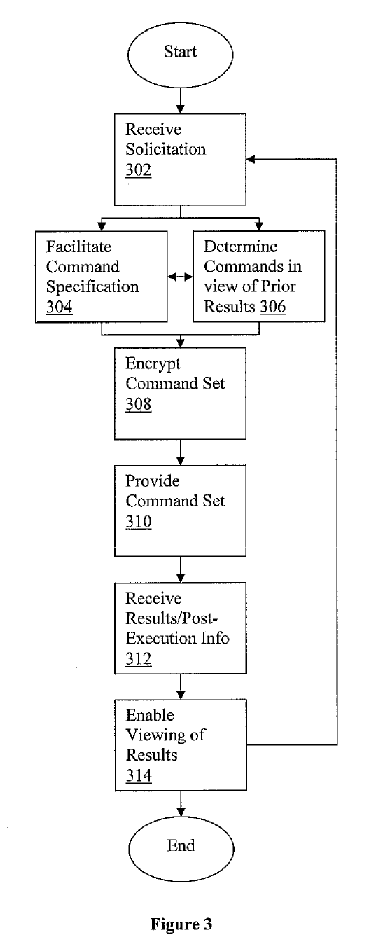

FIG. 3 illustrates a first flowchart view of selected command server operations, in accordance with various embodiments. As illustrated, a command server may receive, from a command agent of a target client environment, a solicitation for a command set, block 302, the target client environment being remotely disposed from the management server system, the target client environment having a firewall restricting access by the management server system. Likewise, the command server and the target client environment may be different enterprises, as described earlier.

In various embodiments, the command server may then facilitate a user of the command server in specifying commands of the command set by presenting the user with one or more selectable commands, block 304. In such embodiments, the user may be associated with a security level, and commands of the command set are associated with the security level. In other embodiments, the command server may determine commands of the command set in view of prior results associated with a prior command set, block 306.

As shown, the command server may then provide the command set to the command agent to provide the command server with a virtual presence within the target client environment and with privileges equivalent to those of another process protected by the firewall, block 310, the command set including one or more commands. In some embodiments, prior to providing, the command server may encrypt the command set with a certificate, block 308, and, if the command set becomes compromised, revoke the certificate. Also, in some embodiments, the commands may direct at least one of a fingerprinting operation, a log file cleanup, a gathering of health statistics, a monitoring directive for a monitoring process of the target client environment, or a directive to fix a fault.

In various embodiments, the command server may next receive from the command agent results and/or post-execution information to enable the command server to determine additional command sets, block 312. In some embodiments, the command server may then enable display of the results and/or post-execution information to a user through a user interface, block 314.

FIG. 4 is a block diagram illustrating an example computer system suitable for use to practice the server aspects of the present invention, in accordance with various embodiments. As shown, computing system 400 includes one or more processors or processor cores 402, and system memory 404. For the purpose of this application, including the claims, the terms “processor” and “processor cores” may be considered synonymous, unless the context clearly requires otherwise. Additionally, computing system 400 includes mass storage devices 406 (such as diskette, hard drive, compact disc read only memory (CDROM) and so forth), input/output devices 408 (such as keyboard, cursor control and so forth) and communication interfaces 410 (such as network interface cards, modems and so forth). The elements are coupled to each other via system bus 412, which represents one or more buses. In the case of multiple buses, they are bridged by one or more bus bridges (not shown).

Each of these elements performs its conventional functions known in the art. In particular, system memory 404 and mass storage 406 may be employed to store a working copy and a permanent copy of the programming instructions implementing all or a portion of the earlier described command agents and command server, herein collectively denoted as 422. The instructions 422 may be assembler instructions supported by processor(s) 402 or instructions that can be compiled from high level languages, such as C.

The permanent copy of the programming instructions may be placed into permanent storage 406 in the factory, or in the field, through, for example, a distribution medium (not shown), such as a compact disc (CD), or through communication interface 410 (from a distribution server (not shown)). That is, one or more distribution media having instructions 422 may be employed to distribute the instructions 422 and program various computing devices.

The constitution of these elements 402-412 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. Those skilled in the art will readily appreciate that the present invention may be implemented in a very wide variety of embodiments or extended therefrom. This application is intended to cover any adaptations or variations of the embodiments discussed herein. Therefore, it is manifestly intended that this invention be limited only by the claims and the equivalents thereof.

What is claimed is:

1. A system comprising:
a command server disposed on a management server; and
a command agent, instances of which are to be correspondingly distributed to a plurality of firewall-protected target client environments remotely disposed from the management server;
wherein the command server and the command agent are complementarily configured, with the command agent configured to solicit the command server for a command set and the command server configured to be responsive to the solicitation, to enable the command server to provide the command set to the target client environments to manage client systems within the target client environments, notwithstanding that the target client environments are firewall-protected.

2. The system of claim 1, wherein the client systems include at least one email server.

3. The system of claim 1, wherein at least some of the target client environments each include a monitoring process configured to monitor its respective target client environment and to provide statistics associated with the monitoring to a remote monitoring server of the management server.

4. The system of claim 1, wherein the command agent is further configured to provide results and/or post-execution information to the command server to enable the command server to determine additional command sets.

5. The system of claim 1, wherein the firewall-protected target client environments are different enterprise entities and the management server is a third party that is unrelated to the different enterprise entities.

6. A method comprising:
soliciting, by a command agent of a target client environment from a command server, a command set, the target client environment being remotely disposed from the command server, the target client environment including a firewall restricting access by the command server;
in response to said soliciting, receiving, by the command agent, the command set, the command set including one or more commands;
executing, by the command agent, at least one of the one or more commands to provide the command server with a virtual presence within the target client environment and with privileges equivalent to those of another process protected by the firewall; and
providing, by the command agent, results and/or post-execution information to the command server to enable the command server to determine additional command sets.

7. The method of claim 6, further comprising repeating, by the command agent, said soliciting on a predetermined basis.

8. The method of claim 6, further comprising, prior to said executing, verifying, by the command agent, privilege information associated with the one or more commands of the command set by comparing the privilege information to locally stored credentials.

9. The method of claim 6, further comprising receiving, by the command agent, additional command sets with the received command set, each additional command set including additional one or more commands, the commands within each command set to be executed serially.

10. The method of claim 6, wherein the results indicate a success or failure status for each of the executed commands.

11. The method of claim 6, wherein communication between the command agent and the command server is secured by a public/private key encryption scheme and/or a certificate.

12. The method of claim 6, wherein the commands direct at least one of a fingerprinting operation, a log file cleanup, a gathering of health statistics, a monitoring directive for a monitoring process of the target client environment, or a directive to fix a fault.

13. The method of claim 6, further comprising:
determining, by the command agent, for each of the commands in the command set, a command type and a security level associated with the command; and
comparing, by the command agent, the security level for each command to a threshold level associated with the command type for that command and, if the threshold is not met, not performing said execute for the command.

14. The method of claim 6, wherein the target client environment is belongs to an enterprise entity and the command server belongs a third party that is unrelated to the enterprise entity.

15. A management server system comprising:
a processor; and
a command server configured to be operated by the processor to
receive from a command agent of a target client environment a solicitation for a command set, the target client environment being remotely disposed from the management server system, the target client environment having a firewall restricting access by the management server system,
provide the command set to the command agent to provide the command server with a virtual presence within the target client environment and with privileges equivalent to those of another process protected by the firewall, the command set including one or more commands, and
receive from the command agent results and/or post-execution information to enable the command server to determine additional command sets.

16. The management server system of claim 15, wherein the command server is further configured to enable display of the results and/or post-execution information to a user through a user interface.

17. The management server system of claim 15, wherein the command server is further configured to facilitate a user of the command server in specifying the commands of the command set by presenting the user with one or more selectable commands.

18. The management server system of claim 17, wherein the user is associated with a security level, and commands of the command set are associated with the security level.

19. The management server system of claim 15, wherein the command server is further configured to determine the commands of the command set in view of prior results associated with a prior command set.

20. The management server system of claim 15, wherein the command server is further configured to encrypt the command set with a certificate and, if the command set becomes compromised, revoke the certificate.

21. The management server system of claim 15, further comprising a remote monitoring server configured to receive health statistics from a monitoring process of the target client environment.

22. The management server system of claim 15, wherein the commands direct at least one of a fingerprinting operation, a log file cleanup, a gathering of health statistics, a monitoring directive for a monitoring process of the target client environment, or a directive to fix a fault.

23. The management server system of claim 15, wherein the target client environment is belongs to an enterprise entity and the management server system belongs to a third party that is unrelated to the enterprise entity.
